(19) United States
(12) Patent Application Publication
(10) Pub. No.: US 2017/0374716 A1
(43) Pub. Date: Dec. 28, 2017

(54) BOOST ENABLED LED BACKLIGHT FOR ENHANCING SUNLIGHT VISIBILITY OF A LIQUID CRYSTAL DISPLAY

(71) Applicant: Kevin Joseph Hathaway, Saratoga, CA (US)

(72) Inventor: Kevin Joseph Hathaway, Saratoga, CA (US)

(21) Appl. No.: 15/635,143

(22) Filed: Jun. 27, 2017

Related U.S. Application Data
(60) Provisional application No. 62/355,181, filed on Jun. 27, 2016.

(51) Int. Cl. H05B 33/08; F21V 8/00

(52) U.S. Cl. CPC H05B 33/0854; G02B 6/0085; G02B 6/0068; G02B 6/0073; G02B 6/0081

(57) ABSTRACT

An improved LCD backlighting unit (“BLU”) particularly a BLU which uses light emitting diode (“LED”) light sources especially white LED light sources, enhances a liquid crystal display's (“LCD's”) readability in sunlight. The improved BLU briefly increases a display screen's brightness, typically 2-6× greater than a BLU's maximum continuous operating brightness. The BLU and its associated LED driver provide substantially increased brightness for a predefined and relatively short interval, typically 2 to 60 seconds, without damage. The LED driver control prevents boosting the display brightness too frequently or for too long thereby avoiding system damage by adequately dissipating the increased power. The BLU may include a thermal sensor on or near the LEDs to provide real time temperature feedback to the LED driver control. Temporarily boosting the BLU's brightness helps any outdoor daylight application such as commercial drones where the sun can easily wash out a display an the drone's controller.

### BACKGROUND

### Technical Field

The present disclosure relates generally to liquid crystal displays (“LCDs”), and more particularly to enhancing an LCD's perceptibility when in sunlight.

### Background Art

Popularity of LCDs have imposed increased demands on their performance particularly when included in portable electronic products such, as smart phones, personal digital assistants (“PDAs”), notebook computers (“notebook PCs”), tablet computers (“tablet PCs”) and so forth. However, LCDs in such portable electronic devices must provide an image that is visible both indoors and outdoors, i.e. in the presence of sunlight. Typically, moving a portable electronic product into strong sunlight washes out the image on the display screen. The main reason that images on LCDs are difficult to view outdoors is that sunlight overpowers a backlight emitting light that passes through the LCD while suit light reflects from the LCD screen. Presently, increasing backlight brightness is commonly used for improving LCDs visibility in glaring light. However, increasing a LCDs visibility in glaring light by increasing backlight brightness is disadvantageous because:
1. a brighter backlight increases a device's electrical power consumption;
2. increased power consumption accelerates the drain of the system battery; and
3. increased power consumption requires greater thermal dissipation or the LCD will likely overheat.

Historically, and particularly for LCD backlighting units (“BLUs”) that includes a light pipe, BLUs usually operate as a fixed brightness light source at a constant maximum brightness. From a practical perspective, operating BLUs at a constant maximum brightness was unavoidable until LED-based BLUs began replacing cold cathode fluorescent (“CCFL”) based BLUs. Using light emitting diodes (“LEDs”) in a LCD's BLU is relatively recent. Beginning around 2008 LED BLUs began rapidly replacing CCFL illumination in LCD BLUs.

FIGS. 1-3 depict a typical commercially designed LCD BLU, identified by the general reference number (18), juxtaposed with a LCD glass panel (04). For purposes of the present description, the relevant components of the BLU (18) include LEDs (01) arranged in an approximately linear LED array (21) stationed in an edge-lit configuration with respect to a light pipe (03). Light emitted from the LEDs (01) enters an input edge (02) of the light pipe (03) which transforms the light into as approximately uniformly lit rectangle that back illuminates the LCD glass panel (04) producing a screen brightness B(0). A typical commercial LCD module includes other mechanical, electrical and optical components in addition to the BLU (18) that are irrelevant to this description and, for clarity, have been omitted from the drawings.

Drive electrical current supplied to LEDs (01) is largely limited by thermal dissipation of the lighting system design and by self-heating of LEDs semiconductor junction. The allowable operating electrical current flowing through LEDs (01) is governed far more significantly by these thermal considerations than a CCFL's operating electrical current. However, an LED (01) may be safely driven at a substantially higher electrical current than its normal continuous operating drive electrical current for short periods of time. The length of such periods depends on the effectiveness of the thermal design of the BLU (18) and the intrinsic thermal conductivity of the LED light source carrier package. Under appropriate circumstances, it is possible to advantageously exploit this fact to temporarily boost the light output of an LED BLU (18) by as much as 2-6 times or more above its continuous operating brightness.

United States Patent Application Publication no. 2012/0188481 A1 entitled “LCD Apparatus” discloses a LCD display apparatus adapted for use outdoors. The disclosed LCD display apparatus includes a pair of LCD modules arranged back to back so each LCD is viewable from one side of the LCD display apparatus. Each LCD module includes a LCD and its associated back panel that includes a backlight module. The LCD modules' back panels, which face each other, are spaced apart to establish a ventilation channel between the back panels. A set of fans located at one end of the ventilation channel blow air longitudinally past the back panels to remove heat generated in the backlight modules and other electronic circuits mounted thereon. A backlight controller responding to an ambient light sensor dynamically controls operation of the backlighting module so LCD backlighting responds to ambient lighting for maintaining a balance between sufficient image brightness, energy preservation and operating life of the LCD panel.

LEDs (01) are commonly known as current devices. They are best powered from a circuit that regulates their input current by carefully monitoring the LED drive current via an active feedback loop. Such a LED driver integrated circuit (“IC”) chip continuously adjusts voltage supplied to the LEDs (01) to maintain a specified electrical current through the LEDs (01). While many such LED driver ICs are commercially available, two examples thereof are a LTC3783 PWM LED Driver and Boost, Flyback and SEPIC Controller made by Linear Technology Corporation 1630 McCarthy Boulevard, Milpitas, Calif., and a HV9912 Switch-mode LED Driver IC With High Current Accuracy and Hiccup Mode Protection made by Supertex, Inc. 1235 Bordeaux Drive, Sunnyvale, Calif.

Output to the LEDs (01) can be user modified from an appropriate input using either pulse width modulation (PWM) or direct control of the driver circuit DC output current. Most LED driver chips have inputs for this kind of control which, of course, can be done by some kind of manual input or automatically in response to an external command as from a microprocessor or other data processing device. These in turn can have various ambient sensing inputs such as thermal and optical sensors giving the system some amount or intelligent decision making ability. In any case, given the very fast response time of typical LEDs (01), it is possible to give a user the ability to rapidly adjust the BLU brightness.

### BRIEF SUMMARY

An object of the present disclosure is to provide a better BLU (18) for viewing a LCD in bright sunlight.

Briefly, the present disclosure includes a method for operating BLU (18) that includes a LED array illumination source. Supplying an electrical current continuously to LEDs included in the LED array causes the LED array to emit illumination that passes through a LCD. The method includes a step of increasing for a brief period of time electrical current supplied to the LEDs. During the brief period of time while the increased electrical current flows through the LEDs, the illumination passing through the LCD increases significantly thereby permitting improved viewing the LCD when in bright sunlight. The present disclosure differs from conventional LED BLU in that the LED BLU (18) is energized for a short interval of time so as to emit a significantly higher brightness than the LED BLU (18) emits during continuous operation at maximum brightness.

Advantages of the present disclosure for momentarily increasing electrical current flowing through LEDs (01) included in the BLU (18) beyond that normally flowing continuously through the LEDs (01) include:
1. reducing cost of a display system capable of such operation;
2. reducing overall electrical power consumed by the BLU (18) significantly thereby either:
   a. extending battery life; and/or
   b. allowing use of a smaller, lighter battery; and
3. reducing both the weight and size of a display system capable of such operation.

A preferred embodiment BLU (18) that operates in accordance with the present disclosure includes more LEDs (01) in the LED array than are included in a conventional LED array. Including more LEDs in the LED array provides two additional benefits for the end user.
1. When operating the BLU (18) continuously at a brightness typical of most commercially designed displays, a lower average LED drive current significantly increases:
   a. LED light generating efficiency; and
   b. correspondingly decreases electrical power consumed by the BLU (18) and heat produced thereby extending operating time for a battery energized device.
2. Decreasing per-LED power consumption and heat generation improves the operating life of the BLU (18) and reliability.

A preferred embodiment BLU (18) that operates in accordance with the present disclosure also includes a thermal ballast in thermal contact with the LED array. This provides a means to extend the total duration of brightness boost by slowing down the rate of temperature rise caused by the increased power to the BLU (18).

These and other features, objects and advantages will be understood by and/or apparent to those of ordinary skill in the art from the following detailed description of the preferred embodiment as illustrated in the various drawing figures.

### BRIEF DESCRIPTION OF THE DRAWINGS

FIG. 1 is a partial cross-sectional elevational view of a typical commercial LCD BLU (18) depicting LEDs of a LED array and of a light pipe for projecting illumination through a LCD;

FIG. 2 is a cross-sectional elevational view of a typical commercial LCD BLU (18) depicting LEDs of the LED (21) array and of the entire light for pipe projecting illumination through the LCD;

FIG. 3 is a partial perspective view of a portion of a typical commercial LCD BLU (18) depicting LEDs mounted of the LED array (21) and the light pipe for projecting illumination through the LCD;

FIG. 4 is an elevational view comparing a density of LEDs of the LED array (21) included in a typical commercial LCD BLU (18) with a greater density of LEDs of a LED array in accordance with a preferred embodiment BLU (18) of the present disclosure;

FIG. 5 is a cross-sectional elevational view of a LCD BLU (18) in accordance with the present disclosure depicting LEDs of the LED array depicted in FIG. 4 and of the entire light pipe for projecting illumination through the LCD;

FIG. 6 is a partial perspective view of a portion of the LCD BLU (18) in accordance with the present disclosure's preferred embodiment depicting LEDs of the LED array shown in FIG. 4 with the greater density LEDs mounted thereon for emitting light into the BLU's light pipe;

FIG. 7 is a plan view illustrating a LCD tablet device that includes a BLU (18) in accordance with the present disclosure having a button thereon that when depressed causes the BLU (18) to temporarily increase illumination projected from the BLU (18) through the LCD

FIG. 8 is an exploded view of the tablet device depicted in FIG. 7 having a BLU (18) in accordance with the present disclosure;

FIG. 9 is a block diagram of a LCD system in accordance with the present disclosure; and

FIG. 10 is a flowchart of a LCD system in accordance with the present invention.

### DETAILED DESCRIPTION

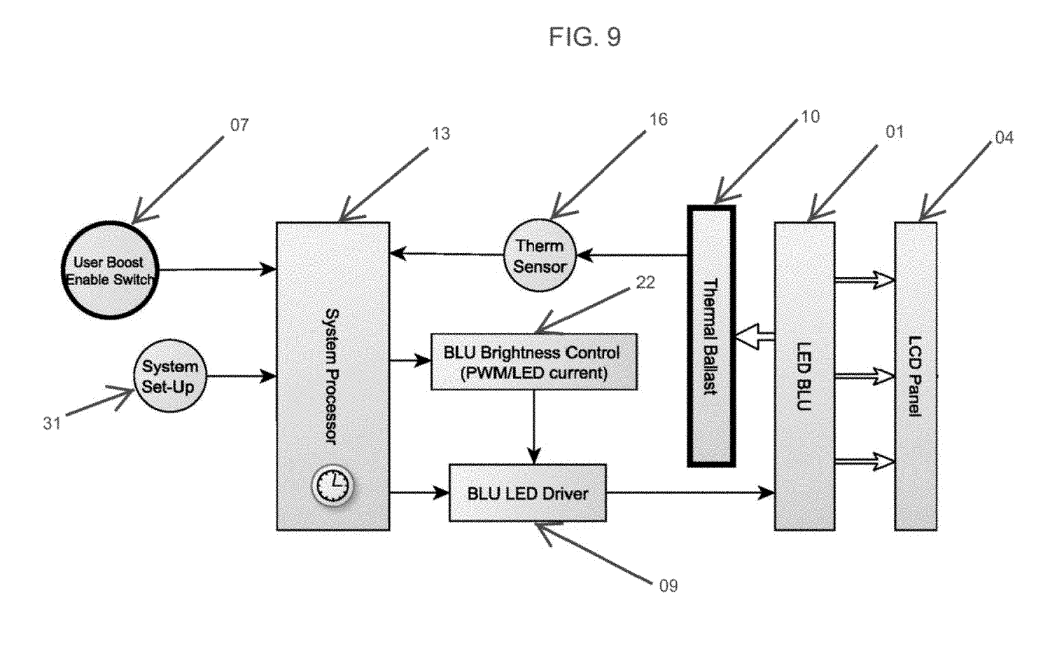

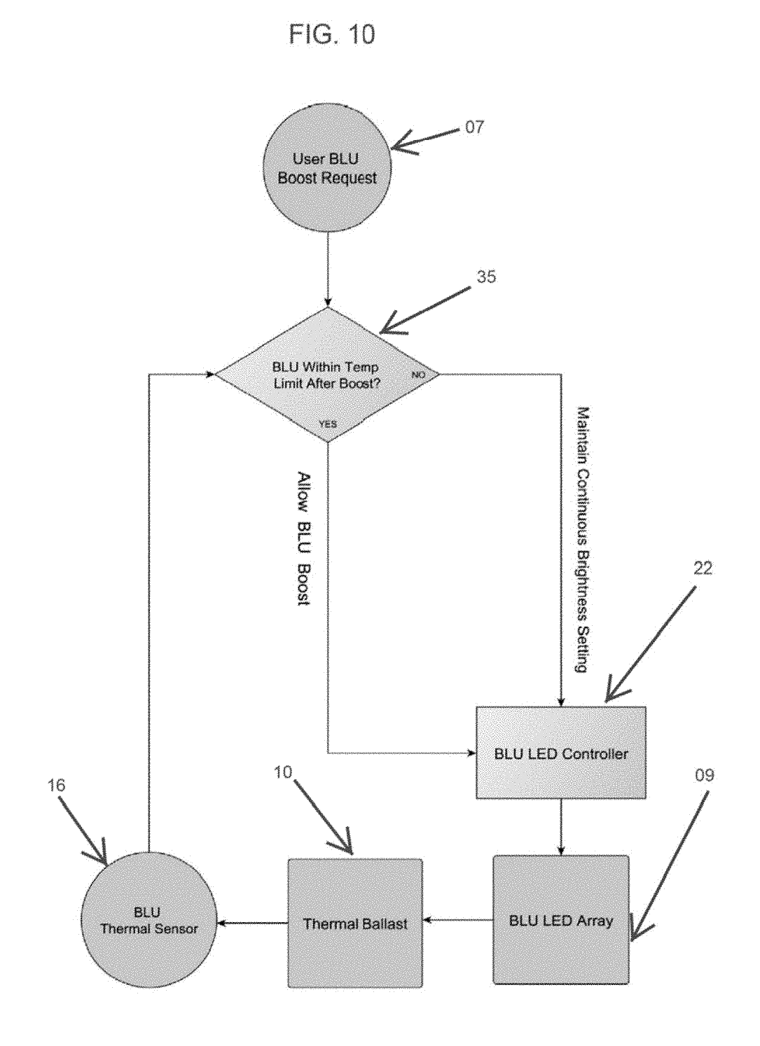

The present disclosure advantageously uses, for enhancing daylight visibility of a LCD, the ability to substantially increase, for short periods of time, electrical current flowing through LEDs (01) included in the BLU (18) above the normal continuous operating electrical current. During the short periods of time, electrical current supplied to the LEDs (01) of the BLU (18) increases to an amount above that supplied for continuous operation. Because of the widespread availability and use of low cost logic and data processing devices, there are numerous ways to configure an electronic system to accomplish the feedback and control functions described in this disclosure. This would be readily apparent to those skilled in the art. However, the functional elements described herein will detail the basic requirements. A BLU brightness control (22) in accordance with the present disclosure, depicted in FIGS. 9 and 10, permits a user to rapidly adjust the root mean square electrical current supplied to LEDs (01) or the BLU (18). But the relevant logic device prevents the user from re-increasing the electrical current too frequently so increased heat generated in the LEDs (01) can be adequately dissipated thereby avoiding LED damage.

As with most electronic components, typical engineering design practice sets LED backlight maximum drive current below the absolute maximum continuous drive operating current specification for a particular LED (01). However, in a BLU (18) operated in accordance with the present disclosure, the thermal mass of the LEDs (01) plus that of associated heat sinking (i.e. a thermal ballast) and dissipation components allows significantly increasing electrical current flowing through the LEDs (01) so long as the increase in electrical current is kept relatively short in duration, for example 15 seconds.

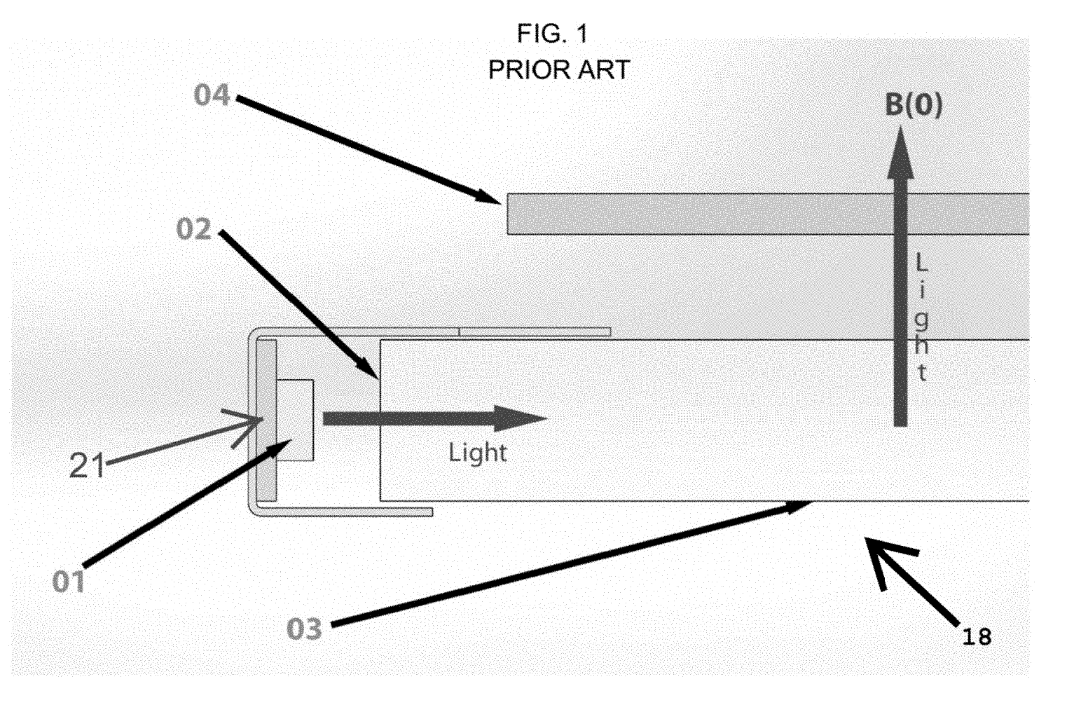

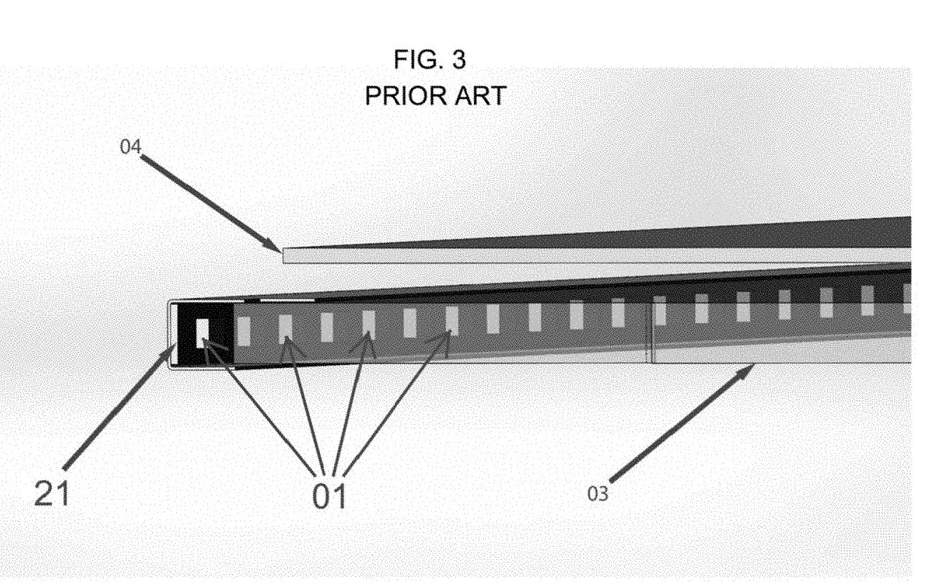

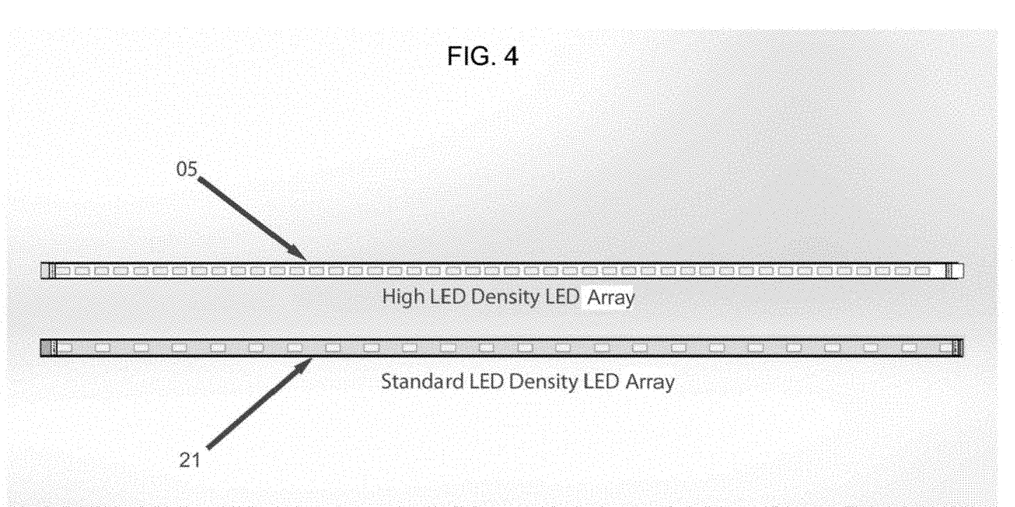

FIG. 4 illustrates a preferred embodiment LED array (05) particularly adapted for operation in accordance with the present disclosure. FIG. 4 graphically depicts a difference in LED density between the standard LED array (21) and a preferred embodiment LED array (05). Consequently, the LED array (05) includes considerably more LEDs (01) than a typical LED array (21) depicted in FIGS. 1-3. Because the LED array (05) has a higher density of LEDs (01) than the standard LED array (21), the preferred embodiment LED array (05):
1. produces significantly more light than LED array (21) when the same amount of electrical current flows through the array of LEDs (01); or
2. alternatively produces the same amount of light for a lesser amount of electrical current flowing through each LED (01) included in the LED array (05).

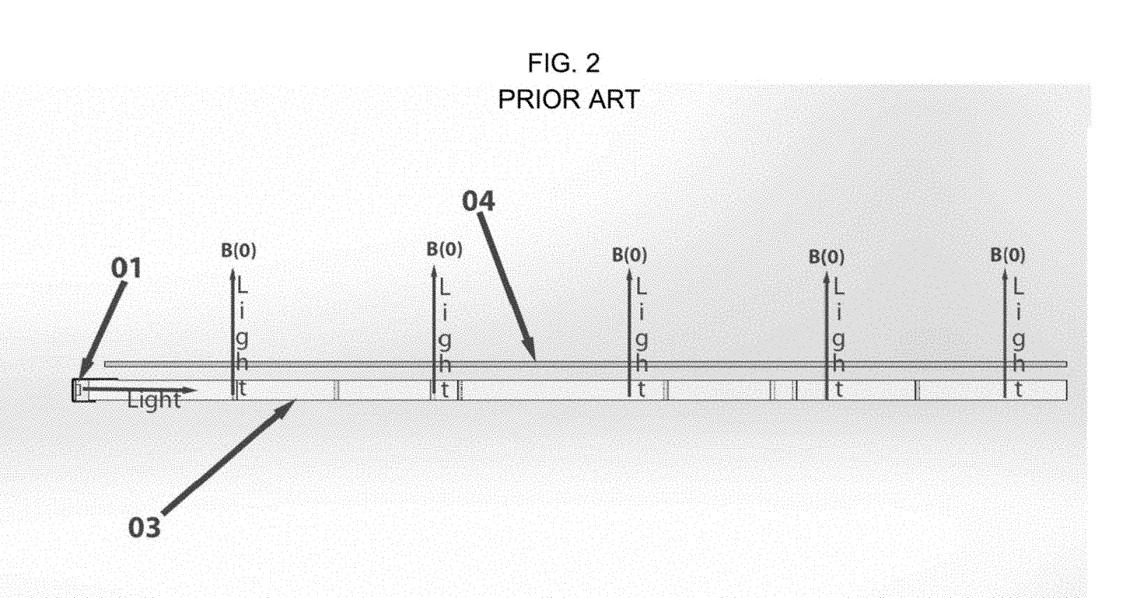

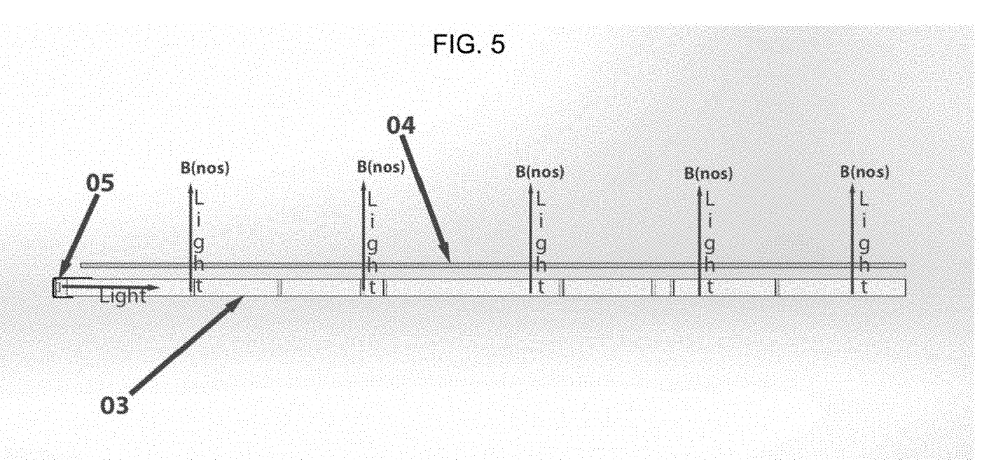

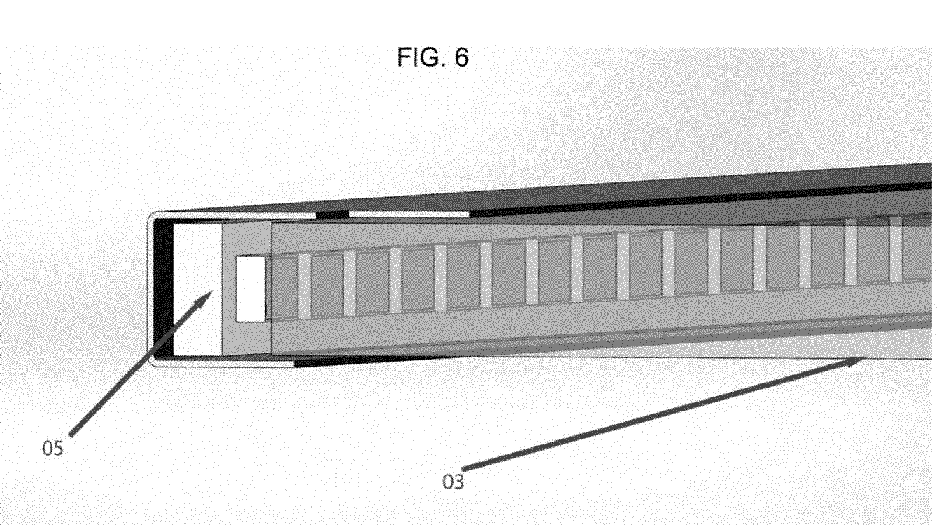

FIGS. 5 and 6 illustrate a BLU (18) that includes the LED array (05) depictions that respectively correspond to FIGS. 2's and 3's drawings. Without damaging the LEDs (01), a much larger total electrical current can flow through LEDs (01) of the LED array (05) than can flow through the conventional LED array (21). This larger total current flowing through LEDs (01) of the LED array (05) correspondingly increases screen brightness B(nos¹) indicated by arrows in FIG. 5. The increased screen brightness B(nos) resulting from light emitted from the LED array (05) that passes through the LCD glass panel (04) depicted in FIG. 5 typically ranges between one and one-quarter (1.25) to six (6) times the continuous screen brightness B(0) of light passing through the LCD glass panel (04) for the conventional BLU (18) depicted in FIGS. 1-3. Herein the acronyms “nos” and “NOS” are applied to the temporarily increased LCD illumination by analogy to a “Nitrous Oxide System” such as those included in high performance motor vehicles for briefly increasing engine output power.

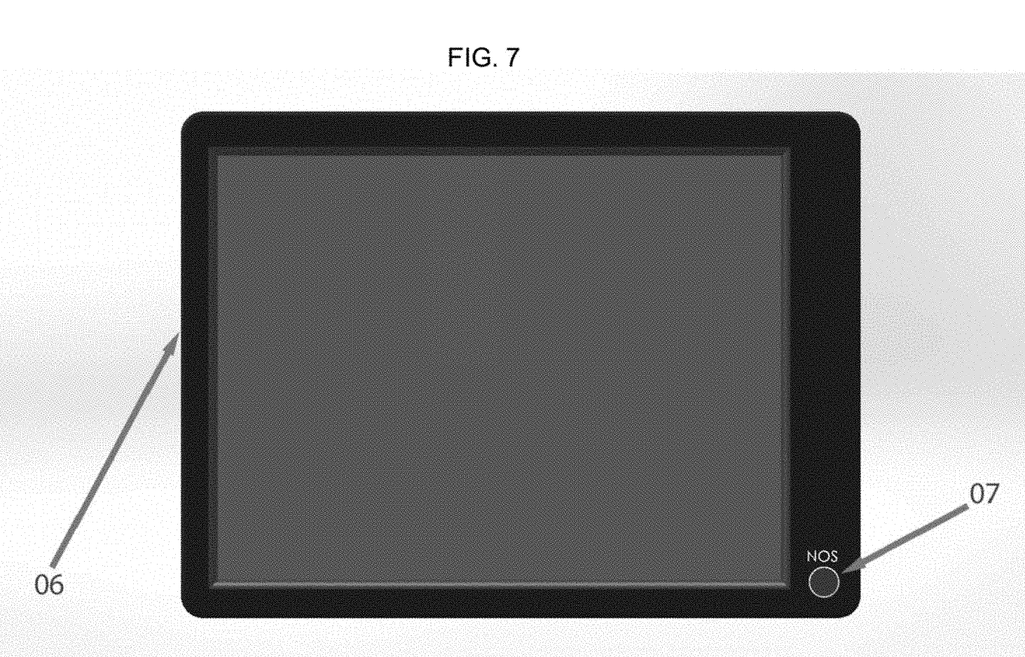

FIG. 7 depicts an exemplary high brightness portable tablet (06) which includes a BLU (18) in accordance with the present disclosure. The tablet (06) includes a NOS button (07) on the front thereof. To increase the brightness of an image appearing on the tablet (06) a user presses the NOS button (07). Specific details of how much the brightness increases arid for how long are controlled by parameters that can either be preset by a manufacturer of the tablet (06) or, programmed by a user of the tablet (06). If the BLU (18) includes a thermal sensor (16), depicted in FIGS. 7, 9 and 10, that responds to the temperature of the BLU (18), this provides an electrical signal to the data processing system (“DPS”) (13) which then determines operating parameters that would prevent the brightness increase from damaging the LEDs (01) included in the LED array (05).

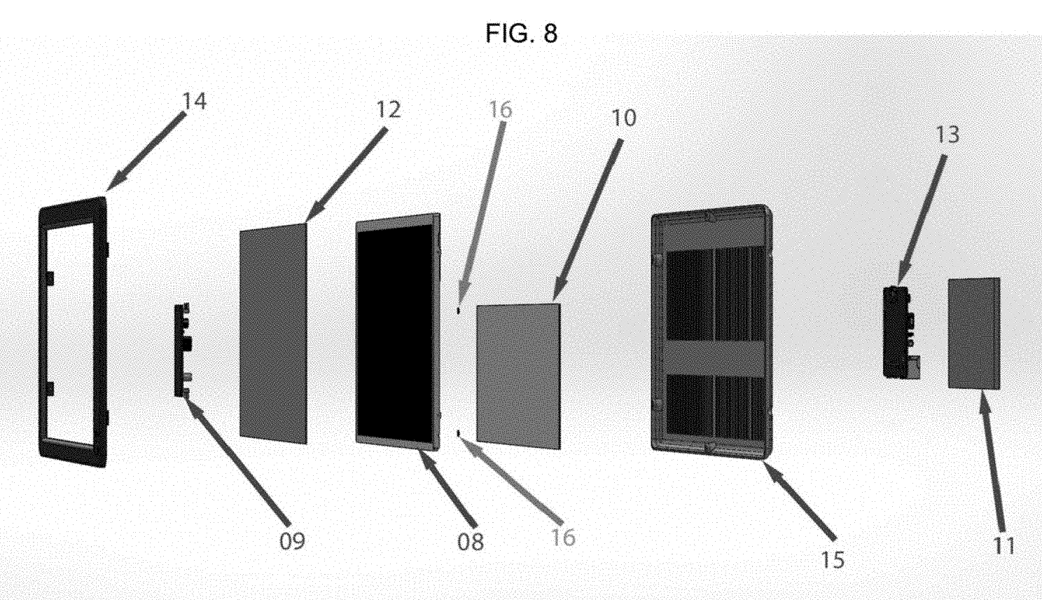

FIG. 8 is an exploded view illustrating various components included in the exemplary high brightness tablet (06) that is adapted for operating in accordance with the present disclosure. Typically, the LCD module (08) includes the LCD glass panel (04), LCD drive electronics not separately depicted in any of the FIGs., a frame and related mechanical mounting means. A BLU (18) that includes the LED array (05) may include one or more thermal sensors (16) for monitoring temperature of the BLU (18). The high brightness tablet (06) includes a LED driver (09) that is capable of supplying sufficient electrical current both:
1. for continuous operation of the LED array (05); and
2. for increasing an image's brightness when a user presses the NOS button (07).
   The LED driver (09) may also provide ail ancillary feedback and control functions required for operating the BLU (18) in accordance with the present disclosure. Alternatively, such functions may reside in other components of the high brightness tablet (06).

Also illustrated in FIG. 8 and included in the high brightness tablet (06) is a heat conducting, spreading and temporary thermal storage layer (10) typically made from aluminum or copper. Alternatively, the heat spreading layer (10) could also be a laminate combining high thermal mass materials and high thermal conduction materials such as copper and graphite, respectively.

The thermal storage layer (10) is thermally coupled to the LED array (05) which in this example is located inside the LCD module (08) horizontally at the bottom thereof. The term “thermally coupled” means that the layer (10) is mechanically affixed adjacent to or in very near proximity to the source or sources of heat produced by the LEDs (01) such that there exists a relatively low thermal resistance heat path from the LEDs (01) into the heat conducting layer (10). The thermal spreading layer (10) conducts excess heat generated by the LED array (05) away from its LEDs (01), most importantly during intervals during which an image's brightness is being increased. The layer (10) also functions as a thermal ballast because it temporarily stores heat produced by the LED array (05) while an image is brightness is being increased. In essence, this arrangement reduces the rate at which temperature the LEDs (01) increases while an image's brightness is being increased. The amount of thermal mass provided by the thermal spreading layer (10) together with the amount of added power consumed by the LED array (05) correlates directly with how long the high brightness tablet (06) may present a brightened image.

The heat storage capacity of the thermal ballast provided by the layer (10) can be significantly increased by replacing the thermal storage layer (10), for example made of copper, with a layer (10) that includes a phase change material (“PCM”) such as Glauber's salt. Glauber's salt, the decahydrate of sodium sulfate Na₂SO_{4:10H2O} which is also identified by the names sal mirabilis (decahydrate), mirabilite (decahydrate) and disodium sulfate, decahydrate, undergoes a phase change at approximately 90° F. In addition to Glauber's salt, other phase change materials, both organic and inorganic, are known each with its unique phase transition temperature. For example an organic mixture of materials known as OM65P, made by RGEES, LLC, 1465 Sand Hill Road, Candler, N.C., changes phase at 149° F.

Strictly by way of example to illustrate the relative increase in thermal storage capacity possible by using a PCM, if the thermal storage material were ice (an unlikely choice), below its freezing point this material would absorb about 0.5 cal/g/° C. Therefore, for every 0.5 calorie absorbed by this thermal storage material, its temperature increases by one degree Celsius per gram of material. But, at the melting point, the ice would absorb about 80 cal/g/° C., a 160× increase in heat absorption capacity.

For use in a device such as the tablet (06), the PCM would be packaged in a relatively thin layer (10), for example 0.5 to 5 mm thick, with a thin inert casing such as is used for lithium ion batteries. As would be apparent to those skilled in the art, it is also be possible to make a multi-layered thermal storage layer (10) each layer using different temperature PCMs thereby extending the temperature range over which the thermal ballast layer (10) provides enhanced thermal energy storage capacity for the LED array (05).

However, the heat spreading layer (10) made of graphite would still be preferred since many PCMs do not exhibit very high thermal conductivity. For example, the literature value of the thermal conductivity of Glauber's salt is approximately 0.6 W/mK whereas the thermal conductivity of many commercially available graphite sheet materials is 400 W/mK or more. Thus, what is accomplished by such a thermal storage layer (10) that includes PCM(s) is both efficient heat spreading away from the LED array (05) via the graphite material and substantial thermal energy storage in the PCM layer or layers.

As would be apparent to those skilled in the art, there exist many possible alternative specific lamellar structures between the thermal conducting layer or layers and the thermal storage layer or layers (10) of the thermal ballast described herein. By way of example, the simplest structure could be a graphite layer laminated to a PCM layer. Alternately, there could be a thermal conduction layer sandwiched between two thermal storage layers (10). Also by way of example, there could be “n” thermal conduction layers interleaved and laminated to thermal storage layers (10). For practical reasons if multiple PCM layers of varying transition temperatures are to be used, it may be preferred if each material is made in a separate physical layer rather than being mixed together into a single layer, assuming that the PCMs are not otherwise microencapsulated.

As would be apparent to those skilled in the art, there are many practical uses for the thermal ballast as described herein other than for use in thermal control of LEDs (01) included in the BLU (18). Any product or system, for example, a battery powered data processor or circuit board, that needs to extend its operating time during adverse thermal operating conditions could benefit from a thermal ballast as described herein.

While the use of a PCM in a thermal ballast can greatly increase the amount of heat that can be temporarily absorbed from a heat source, ultimately, the thermal ballast will have a finite heat absorbing capacity. Therefore, as part of the thermal design of this or any heat generating system, there must be a means whereby the PCM can externally exhaust absorbed heat. In the instance of the BLU (18) systems described herein, typically the DPS (13) monitors the overall system thermal environment and will prevent the user from inadvertently commanding the system into thermal overload. The primary means for this is to allow the system enough time to dissipate the excess heat back into the ambient environment. This scenario will be discussed in more detail later.

FIG. 9 is a block diagram of a display system in accordance with the present disclosure. The block diagram illustrates the preferred embodiments in the present disclosure which include a thermal ballast layer (10) and a thermal sensor (16) for monitoring the temperature of the thermal ballast layer (10). Both a boost request, that a user may present by pressing the NOS button (07), and a system set-up input (31), appear in the FIG. 9 block diagram. The DPS (13) illustrated in FIG. 9 includes a clock icon to indicate that lacking either the thermal sensor (16) or thermal ballast layer (10), the DPS (13) is capable of determining if a brightness increase is still possible based solely upon timing considerations, as explained in the next paragraph.

FIG. 10 illustrates a functional flowchart of feedback and control functions for controlling brightness increase(s) by the user in accordance with the present disclosure. Starting from a brightness boost request that a user may present by pressing the NOS button (07), in decision block (35) the DPS (13) determines if it is safe to allow the request. This is minimally determined by the BLU's thermal design and the user's amortized cumulative brightness increase request(s). If a BLU-associated thermal sensor (16) is included in the system design then accurate real time data is available for analyzing the user request. Otherwise, the DPS (13) must rely on embedded designer-programmed a-priori knowledge of the un-boosted BLU power consumption obtained during product design and testing. In this case, the designer(s) must rely on timing and experimentally measured heat dissipation characteristics of the system to appropriately program the response of the DPS (13) to brightness boost requests.

As illustrated in FIG. 8, the exemplary high brightness tablet (06) includes a front (14) and rear (15) of a case that enclose other components included therein. While not required for practicing the present disclosure, as illustrated in FIG. 8 the exemplary high brightness tablet (06) will generally include a lithium ion battery (11), a touch panel (12) and a DPS (13) such as an ARM-based single board computer. The DPS (13), different types of which are widely available, will typically include a video/graphics controller to interface with and drive the LCD module (08) as well as both a USB port and a HDMI port, that are not separately illustrated in FIG. 8. If the LED driver (09) of the BLU were to omit feedback and control functions, alternatively such functions could be included In firmware executed by the DPS (13). The touch panel (12) requires a controller which may or may not be integrated into the DPS (13) and/or the LED driver (09). The DPS (13) may also include a Wi-Fi transceiver to allow the tablet (06) to video link wirelessly with a video camera such as is frequently included in a smart phone, tablet or any other appropriately capable mobile computing platform, and/or telemetry received from a drone or drone controller or any other remotely controlled system.

Temporarily boosting brightness helps applications such as commercial drone controllers which are most often operated outdoors in daylight where the sun can easily wash out the drone camera image and/or telemetry feeds appearing on the pilot's video monitor. For example, a drone's operator who is outdoors in daylight relies to some degree on the drone's video camera and telemetry data to control the drone's flight and operation. However, in such an environment viewing a video monitor can become difficult because of ambient reflections and sunlight failing on the front (14) of the display screen. When the drone's operator becomes aware that the drone is entering a critical part of its flight, the operator wants to ensure being able to clearly see everything on the LCD. Therefore, when such an event occurs the drone's operator can, in accordance with the present disclosure, initiate a period of increased screen brightness B(nos) having a preselected duration, e.g. 10 seconds.

Since most flight control systems for commercial drones are battery operated, if the BLU (18) operated continuously at the increased screen brightness B(nos), the flight control battery would discharge much more rapidly. However, in accordance with the present disclosure a drone's operator can view the drone's video and/or telemetry feeds under all ambient conditions without increasing the flight control's weight and/or while avoiding significant compromise of the flight control's battery life. As is readily apparent, any outdoor daylight application of an LCD display could advantageously operate in accordance with the present disclosure.

A possibility exists that one could simply increase the drive current provided to a conventionally designed LED illuminator array (21), as are typically found in consumer grade electronic devices, to boost the screen brightness B(nos). But such operation of a conventional BLU (18) has the disadvantages of:

1. significantly shortening the operating life of the BLU (18);

2. decreasing the reliability of the LCD module (08); and

3. shortening the available run time of a system's battery.

By way of comparative example, the BLU in a 12.1″ XGA display module is designed to achieve a maximum continuous screen brightness B(0) of 500 nits (i.e., cd/m²). The LED strip of the LED array (21) in such a BLU is designed to dissipate approximately 5W continuously to produce the preceding continuous screen brightness B(0). In accordance with the present disclosure, the LED array (21) is replaced by the LED array (05) that is capable of emitting substantially more light without exceeding the maximum allowable current for its LEDs (01). For example, if the LED array (05) were to safely operate at approximately 20W, the resulting boosted screen brightness B(nos) could be approximately 8000 nits. Lacking the high LED density LED array (05), it is unlikely that a conventional LED array (21) could withstand dissipating such a power increase without failing or melting something inside the tablet (06). However, a conventional consumer grade electronic device might survive without damage a more modest temporary 1.25 to 2.0 brightness increase, i.e 625 nits to 1000 nits.

However, such increased power dissipation could not be sustained indefinitely without modifying cooling of the LED array (21). A BLU (18) in accordance with the present disclosure allows the LCD module (03) to operate for at least 15 seconds without exceeding the BLU's temperature or current limits. The combination of the DPS (13), the BLU brightness control (22) and the LED driver (09) permits a user to initiate periods of increased screen brightness B(nos) either using the NOS button (07) or via a soft button control or other convenient means for temporarily increasing electrical power supplied to the LEDs (01) as much as 3 times or more for a period of 2-20 seconds or more before returning to its preselected continuous brightness setting.

Consider the BLU (18) in a conventional 12.1″ XGA display module being driven at its normal, continuous maximum brightness, e.g. 5W, and the equilibrium temperature directly adjacent to the LED array (21) is 35° C. Also, assume that the maximum manufacturer-rated operating temperature for this display module is 70° C. Further assume that increased screen brightness B(nos) were enabled for a preselected duration of 15 seconds. Hypothetically, based upon operational testing while designing the conventional 12.1″ XGA display module it were known that a 15 second 15W input power increase to the LED array (21) causes a temperature increase of 15° C. Since a temperature of 50° C. is still well within the normal operating parameters both for the LCD glass panel (04) and for the BLU, then the DPS (13) would permit such an increase in screen brightness to B(nos).

After such a 15 second period of increased screen brightness B(nos) when the BLU returns to its original power and brightness level, assume that a user were to immediately start another period of increased screen brightness B(nos). Since insufficient time has elapsed for heating due to the increased screen brightness B(nos) to have fully dissipated, the initial starting temperature of the LCD glass panel (04) and of the BLU for the subsequent 15 second period of increased screen brightness B(nos) is approximately 50° C. After a second 15 seconds of 15W power input to the LED array (21) its temperature would be approximately 65° C. (actually somewhat less but this is not important to the current example). Again, this is within the normal operating range of this display module so the DSP (13) would permit such a second increase in screen brightness to B(nos).

Again, immediately after the second increase in screen brightness B(nos) a user were to immediately start a third period of increased screen brightness B(nos). The projected temperature of the LCD glass panel (04) and of the BLU at the end of the period will be somewhat less than 80° C. which exceeds the temperature rating for the conventional 12.1″ XGA display module. Therefore, the DSP (13) would not permit the third successive period of increased screen brightness B(nos) until the temperature of the LCD glass panel (04) and of the BLU has decreased to approximately 55° C. at which time another period of increased screen brightness B(nos) could be safely permitted.

As is readily apparent, including the thermal sensors (16) in the LCD module (08) assists in preventing the LEDs (01) from being damaged by a period of increased screen brightness B(nos). Alternatively, if the DSP (13) records how much the power has been increased to the LEDs (01) and for what duration and how much time has elapsed, since the most recent period of increased screen brightness B(nos), it is also possible to prevent the LEDs (01) from being damaged by a period of increased screen brightness B(nos).

Although the present disclosure has been described in terms of the presently preferred embodiment, it is to be understood that such disclosure is purely illustrative and is not to be interpreted as limiting. For a portable video monitor, the screen brightness can be temporarily increased almost instantaneously by as much as 2-6 times above its continuous operation brightness. However, a screen brightness increase of as little as 2.25× would still be within the scope of the present disclosure. Also within the scope of the present disclosure would be simply overdriving LEDs (01) a conventional LED array (05), although as explained previously such operation carries a number of disadvantages. Consequently, without departing from the spirit and scope of the disclosure, various alterations, modifications, and/or alternative applications will, no doubt, be suggested to those skilled in the art after having read the preceding disclosure. Accordingly, it is intended that the following claims be interpreted as encompassing all alterations, modifications, or alternative applications as fall within the true spirit and scope of the disclosure including equivalents thereof. In effecting the preceding intent, the following claims shall:
1. not invoke paragraph 6 of 35 U.S.C. §112 as it exists on the date of filing hereof unless the phrase “means for” appears expressly in the claim's text;
2. omit all elements, steps, or functions not expressly appearing therein unless the element, step or function is expressly described as “essential” or “critical;”

3. not be limited by any other aspect of the present disclosure which does not appear explicitly in the claim's text unless the element, step or function is expressly described as “essential” or “critical;” and

4. when including the transition word “comprises” or “comprising” or any variation thereof, encompass a non-exclusive inclusion, such that a claim which encompasses a process, method, article, or apparatus that comprises a list of steps or elements includes not only those steps or elements but may include other steps or elements not expressly or inherently included in the claim's text.

What is claimed is:

1. A method for operating a backlighting unit (“BLU”) that includes a LED array (21) so that when an electrical current is supplied continuously to LEDs (01) included in the LED array (21) the LED array (21) emits illumination that passes through a liquid crystal display (“LCD”), the method comprising a step of increasing for a brief interval of time electrical current supplied to the LEDs (01) whereby illumination passing through the LCD increases significantly thereby permitting viewing the LCD when in bright sunlight.

2. The method of claim 1 wherein the increased electrical current at least doubles illumination passing through the LCD.

3. The method of claim 1 wherein the increased electrical current at least triples illumination passing through the LCD.

4. The method of claim 1 wherein the increased electrical current at least quadruples illumination passing through the LCD.

5. The method of claim 1 wherein the increased electrical current at least quintuples illumination passing through the LCD.

6. The method of claim 1 wherein the increased illumination is no less than 3000 nits (cd/m²).

7. The method of claim 1 wherein the increased illumination lasts for at least 15 seconds.

8. The method in claim 1 wherein the excess heat generated by the LEDs is temporarily stored in a thermal ballast comprised of a high thermal conductivity layer laminated to a high heat capacity layer.

9. The method in claim 8 wherein the high thermal conductivity layer is a sheet of graphite.

10. The method in claim 8 wherein the high thermal conductivity layer is a sheet of copper.

11. The method in claim 8 wherein the high heat capacity layer is made of a phase change material.

12. The method in claim 11 wherein the layer of phase change material includes as Glauber's salt.

13. The method in claim 8 wherein the high heat capacity layer is made of an organic phase change material known as OM65P, made by RGEES, LLC.

14. The method in claim 8 wherein the high heat capacity layer is made from a combination of phase change materials respectively having different transition temperatures.
